(19) United States
(12) Patent Application Publication
(10) Pub. No.: US 2020/0118103 A1
(43) Pub. Date: Apr. 16, 2020

(54) BILLING INFORMATION GENERATION SUPPORT METHOD, BILLING INFORMATION GENERATION SUPPORT PROGRAM, AND BILLING INFORMATION GENERATION SUPPORT APPARATUS

(71) Applicant: HITACHI, LTD., Tokyo (JP)

(72) Inventor: Yujirou ICHIKAWA, Tokyo (JP)

(73) Assignee: HITACHI, LTD., Tokyo (JP)

(21) Appl. No.: 16/573,625

(22) Filed: Sep. 17, 2019

(30) Foreign Application Priority Data
Oct. 12, 2018 (JP) 2018-193901

(51) Int. Cl. G06Q 20/14

(52) U.S. Cl. CPC G06Q 20/145

(57) ABSTRACT

A billing information generation support apparatus stores: usage amount information including a usage amount of a function publishing a service program regarding an intermediation apparatus to provide the service program from a providing business operator to a utilization business operator; a billing information item generator for determining an information item required to generate the billing information from both the usage amount information and contract information; and a contract related term data source that acquires a value of the information item from the usage amount information or the contract information. The apparatus accumulates the usage amount based on scanning intermediation history from the intermediation apparatus; determines the information item on the basis of the combination and acquires the value of the information item based on the determined information item with reference to the contract-related term data source.

### TECHNICAL FIELD

The present invention relates to a billing information generation support method, a billing information generation support program, and a billing information generation support apparatus.

### BACKGROUND ART

In recent years, a monetization model for software services has been shifting to a measured rate system. Regarding the measured rate system, it is indispensable to measure a usage amount of a product (such as a back-end service) and calculate an amount of money from the usage amount and a price plan which is defined in advance (such as a unit price of the product). Meanwhile, for the purpose of enhancement of the convenience of an API (Application Programming Interface), API publication for back-end services by utilizing an API gateway service which provides certification and authorization, intermediation of requests, flow control, and so on has become the mainstream in recent years. When an API is to be published through the API gateway service, an efficient mechanism for the measured rate system is required between a back-end service business operator, an intermediation service business operator who operates the API gateway, and a back-end service utilization business operator.

### CITATION LIST

### Patent Literature

PTL 1: Japanese Patent Application Laid-Open Publication No. 2016-224578

### SUMMARY OF THE INVENTION

### Problems to be Solved by the Invention

PTL 1 prepares cooperation processing for intermediating data input/output API's between SaaS's (Software as a Service: an example of a billing management service for executing charging processing based on billing information [which client has used what product to what extent]) and performs data cooperation between the SaaS's. PTL 1 performs input/output cooperation between API's of the same data format, but cannot deal with cases of converting ID information (example: when converting a Client ID to a client's name) or changing data input/output granularity.

The present invention was devised in consideration of the above-described circumstances and it is an object of the invention to automate charging by dynamically generating billing information required for a charging action, which is premised on management information of a contract and billing management system used by the back-end service business operator, from the usage amount of the back-end service.

### Means to Solve the Problems

In order to solve the above-described problems, provided according to the present invention is a billing information generation support method executed by a billing information generation support apparatus for supporting generation of billing information to be transmitted from an intermediation business operator to a billing and charging management apparatus of a provider business operator with respect to intermediation of function provision of a service program from the provider business operator to a user business operator through communication via an intermediation apparatus of the intermediation business operator, wherein the billing information generation support apparatus includes a storage unit that stores: usage amount information that retains a usage amount of a function publishing the service program regarding which the intermediation apparatus intermediates to provide the service program from the provider business operator to the user business operator; a billing information item generation method for determining an information item which is required to generate the billing information from a combination of the usage amount information and contract information retained by the billing and charging management apparatus; and a contract-related term data source that retains a method for acquiring a value of the information item from the usage amount information or the contract information; wherein a billing information generation processing unit of the billing information generation support apparatus accumulates the usage amount, which is determined by scanning intermediation history acquired from the intermediation apparatus with respect to one or more indexes, in the usage amount information and generates the billing information from the usage amount information and the contract information; wherein a billing information complementation processing unit of the billing information generation support apparatus determines the information item, which is required by the billing information generation processing unit when generating the billing information, on the basis of the combination with reference to the billing information item generation method and acquires the value of the information item from the usage amount information or the contract information by using the method for acquiring the value of the information item acquired on the basis of the determined information item with reference to the contract-related term data source; and wherein the billing information generation processing unit generates the billing information from the information item and the value of the information item which are determined by the billing information complementation processing unit.

### Advantageous Effects of the Invention

Charging can be automated according to the present invention by dynamically generating the billing information required for the charging action, which is premised on management information of the contract and billing management system used by the back-end service business operator, from the usage amount of the back-end service.

### BRIEF DESCRIPTION OF DRAWINGS

FIG. 1 is a diagram illustrating contract and communication relationships between business operators according to Embodiment 1;

FIG. 2 is a diagram illustrating an example of the configuration of a billing information generation support apparatus according to Embodiment 1;

FIG. 3 is a diagram illustrating an example of the structure of intermediation history according to Embodiment 1;

FIG. 4 is a diagram illustrating an example of the structure of a usage amount according to Embodiment 1;

FIG. 5 is a diagram illustrating an example of the structure of billing information according to Embodiment 1;

FIG. 6 is a diagram illustrating an example of the structure of a billing information item generation method according to Embodiment 1;

FIG. 7 is a diagram illustrating an example of the structure of a contract-related term data source according to Embodiment 1;

FIG. 8 is a diagram illustrating an example of a processing flowchart of a billing information generation processing unit and a billing information complementation processing unit according to Embodiment 1;

FIG. 9 is a diagram illustrating an example of the configuration of a billing information generation support apparatus according to Embodiment 2;

FIG. 10 is a diagram illustrating an example of the structure of a billing target metric according to Embodiment 2;

FIG. 11 is a diagram illustrating an example of a processing flowchart of a billing information generation processing unit and a usage amount filtering processing unit according to Embodiment 2;

FIG. 12 is a diagram illustrating an example of the configuration of a billing information generation support apparatus according to Embodiment 3;

FIG. 13 is a diagram illustrating an example of the structure of segmentation information according to Embodiment 3;

FIG. 14 is a diagram illustrating an example of the structure of a usage amount according to Embodiment 3;

FIG. 15 is a diagram illustrating an example of the structure of intermediation history according to Embodiment 3;

FIG. 16 is a diagram illustrating an example of the structure of billing information according to Embodiment 3;

FIG. 17 is a diagram illustrating an example of a processing flowchart of a billing information generation processing unit according to Embodiment 3; and

FIG. 18 is a diagram illustrating an example of the configuration of a computer that implements, for example, the billing information generation support apparatus.

### DESCRIPTION OF EMBODIMENTS

Embodiments of the present invention will be described below in detail with reference to the drawings. The following embodiments do not limit the present invention. Furthermore, the same reference numerals in the respective drawings to explain the following embodiments indicate constituent elements or processing equipped with the same or similar functions, so that any subsequent explanations will be omitted. Furthermore, a part or whole of every embodiment and every variation can be combined with the range of the technical idea of the present invention and within the range of conformity.

### Embodiment 1

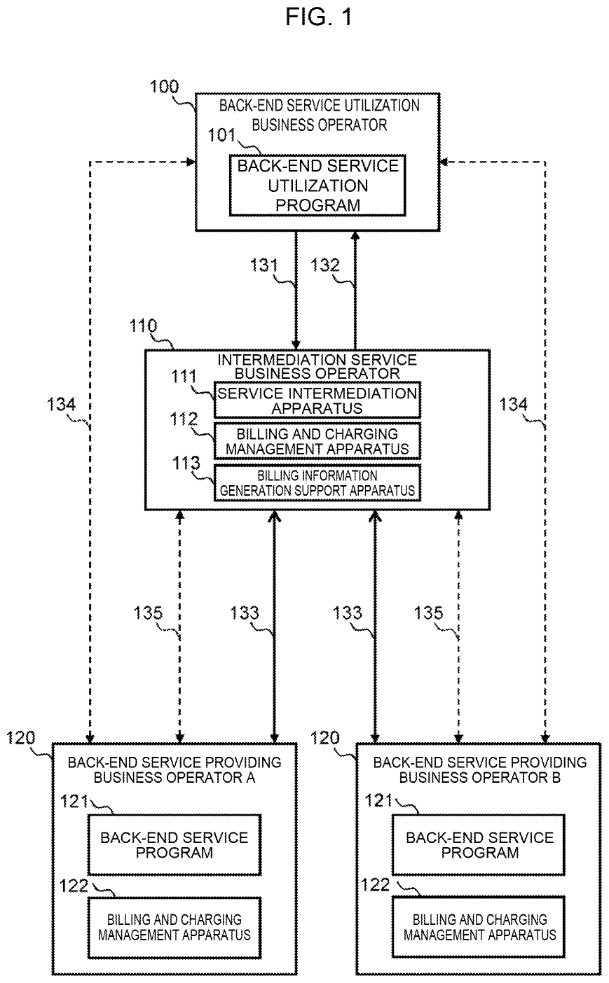

FIG. 1 is a diagram illustrating contract and communication relationships between business operators according to Embodiment 1. In an example of FIG. 1, a back-end service utilization business operator 100, an intermediation service business operator 110, and back-end service providing business operators 120 exist.

Regarding a contract relationship 134, the back-end service utilization business operator 100 enters into a back-end service use contract, which is based on a measured rate system for charging and payment according to a usage amount of a back-end service, with a back-end service providing business operator 120.

Regarding a contract relationship 135, the back-end service providing business operator 120 enters into a contract, which is based on the measured rate system for charging and payment according to the usage amount of the back-end service, with the intermediation service business operator 110 to publish a back-end service program 121 to the back-end service utilization business operator 100 through a service intermediation apparatus 111 such as an API gateway in order to provide the back-end service program 121 to the back-end service utilization business operator 100 in a convenient form such as an API.

Regarding a communication relationship 131, a back-end service utilization program 101 evokes a function publishing the back-end service program (such as an API), which is registered in the service intermediation apparatus 111, based on an HTTP communication or the like.

Regarding a communication relationship 133, the service intermediation apparatus 111 transfers a request content of the communication relationship 131 to the back-end service program 121 on the basis of policies for security, load distribution, and so on.

Regarding a communication relationship 132, the service intermediation apparatus 111 transmits a response (the execution result of the function provided by the back-end service program 121) to the request content, which has been transferred in the communication relationship 133, to the back-end service utilization program 101.

Billing and charging management apparatuses 122 and 112 provide necessary business process to implement the contract relationship 134.

A billing information generation support apparatus 113 generates billing information, which is required for a charging action among the business process provided by the billing and charging management apparatuses 112 and 122, and transmits the generated billing information to the billing and charging management apparatuses 112 and 122.

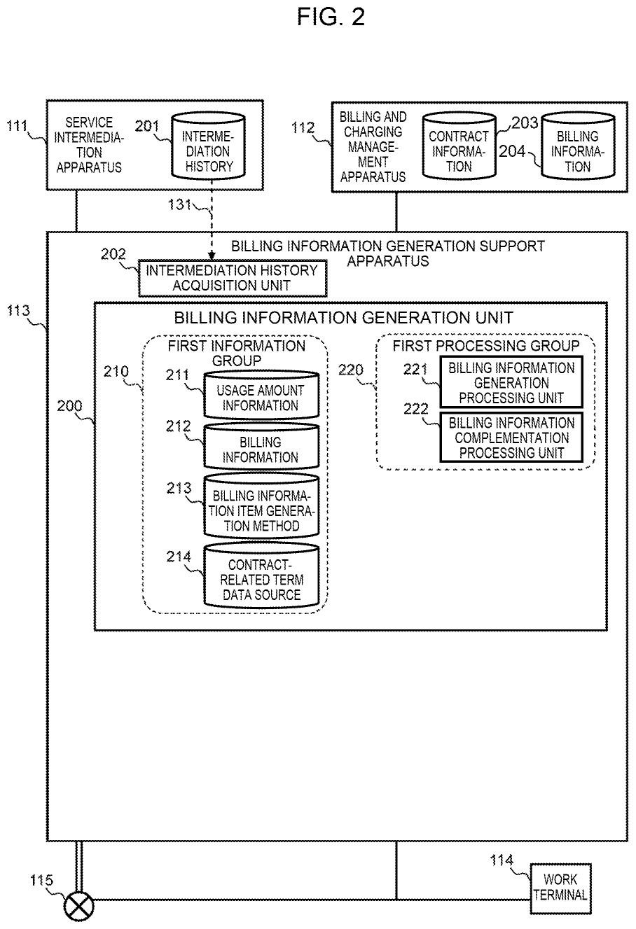

FIG. 2 is a diagram illustrating an example of the configuration of the billing information generation support apparatus according to Embodiment 1. FIG. 2 illustrates an example of a program configuration of the billing information generation support apparatus 113 and an example of information in the service intermediation apparatus 111 and the billing and charging management apparatus 112, on which the billing information generation support apparatus 113 is premised.

The service intermediation apparatus 111 and the billing and charging management apparatus 112, on which the billing information generation support apparatus 113 is premised, and a work terminal 114 for operating the billing information generation support apparatus 113 are connected via a network 115.

The service intermediation apparatus 111 includes intermediation history 201 as execution history of the communication relationships 131 to 133. The billing and charging management apparatus 112 includes: contract information 203 which retains contract-related information (such as a contract name, a client's name, and a product name); and billing information 204 used to execute charging. An intermediation history acquisition unit 202 of the billing information generation support apparatus 113 acquires the intermediation history 201 from the service intermediation apparatus 111 through the communication relationship 131 based on, for example, an API call on the HTTP.

The billing information generation support apparatus 113 has a billing information generation unit 200 implemented by execution of a program(s) and an intermediation history acquisition unit 202. The billing information generation unit 200 has a first information group 210 and a first processing group 220. The first information group 210 is, for example, information stored in a storage unit. The first processing group 220 is, for example, to be implemented by processing of each unit by an arithmetic processing unit executing a program(s).

The first information group 210 has: usage amount information 211 which retains the usage amount of the back-end service program 121 calculated from the intermediation history 201; billing information 212 which retains the billing information to be transmitted to the billing and charging management apparatus 112; a billing information item generation method 213 which manages a method for determining value of information item, on which the billing information 212 is premised, from the usage amount information 211 or the contract information 203; and a contract-related term data source 214 which manages a method for acquiring the value of the information item, which are required by the billing information item generation method 213, from the usage amount information 211 and the contract information 203.

The first processing group 220 has: a billing information generation processing unit 221 which generates final billing information; and a billing information complementation processing unit 222 which determines the respective values of the information items of the billing information generated by the billing information generation processing unit 221.

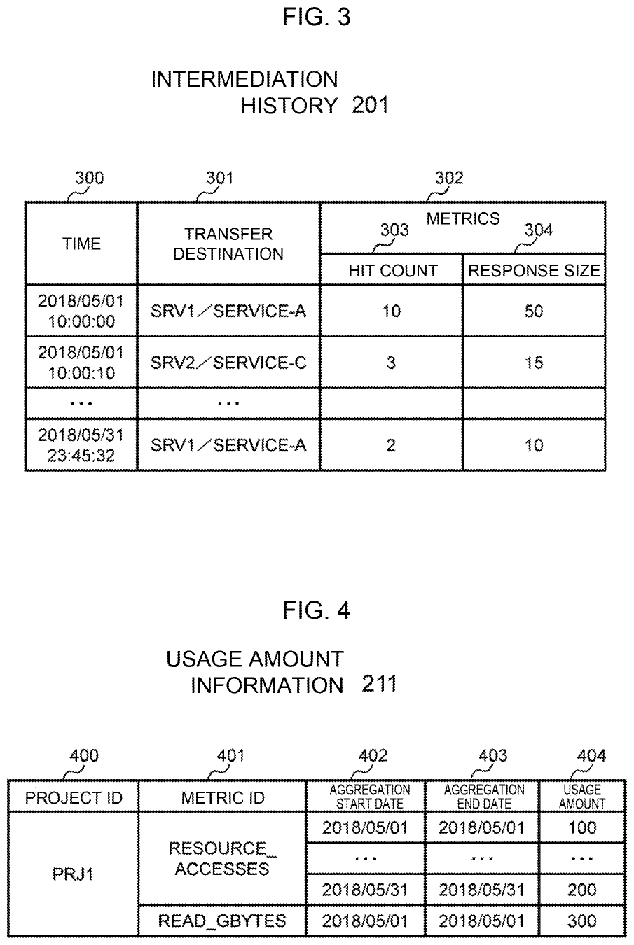

FIG. 3 is a diagram illustrating an example of the structure of the intermediation history according to Embodiment 1. The intermediation history 201 includes: time 300 when the intermediation took place; a transfer destination 301 for identifying a transfer destination back-end service of the relevant request; and metrics 302 indicating statistic information of intermediation processing.

The transfer destination 301 is information, like an example of “SRV1/SERVICE-A” indicated in FIG. 3, which is capable of identifying the back-end service providing business operator 120 and the back-end service program 121; and, for example, when the back-end service providing business operator 120 publishes an HTTP API as the back-end service program 121, its URL or another name which is set by the intermediation history 201 becomes the transfer destination 301.

The metrics 302 have one or more sub-columns and include, for example, a hit count 303 which is the number of times a request was transmitted to the transfer destination 301, and a response size 304 indicating the size of data returned by the back-end service.

FIG. 4 is a diagram illustrating an example of the structure of the usage amount according to Embodiment 1. The usage amount information 211 includes: a project ID 400 for identifying the back-end service utilization business operator 100, a tenant in the back-end service utilization business operator 100, or the back-end service utilization program 101; a metric ID 401 for identifying the relevant metric used when measuring the usage amount based on a specified index (metric) from the intermediation history 201; an aggregation start date 402 indicating a start date of a measurement period; an aggregation end date 403 indicating an end date of the measurement period; and a usage amount 404 which is a numerical value of the measurement result.

The aggregation start date 402 and the aggregation end date 403 are used to filter the information of the intermediation history 201, which is a measurement object, based on date-and-time information in advance. In this embodiment, the aggregation start date 402 and the aggregation end date 403 are retained as year-month-date information, but they may be retained as date-and-time information.

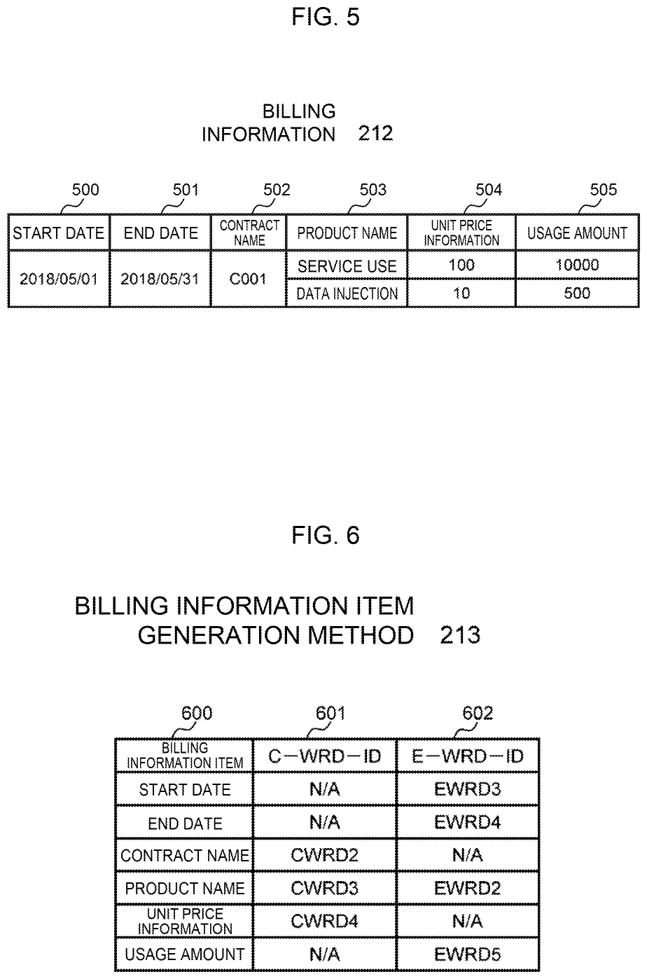

FIG. 5 is a diagram illustrating an example of the structure of the billing information according to Embodiment 1. The billing information 212 includes: a start date 500 indicating a start date of a charge target period; an end date 501 indicating an end date of the charge target period; a contract name 502 capable of identifying the relevant contract; a product name 503 capable of identifying a contract target product; unit price information 504 for calculating a final billed amount; and a usage amount 505 indicating the billed amount according to the usage amount of the product. The final billed amount is calculated by, for example, multiplying the unit price information 504 by the usage amount 505.

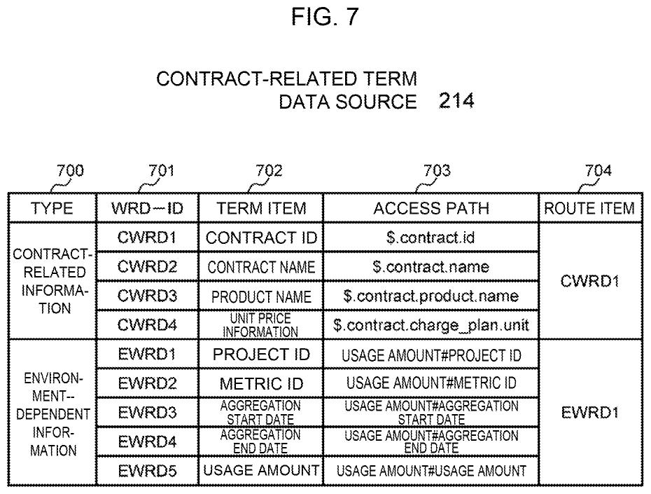

FIG. 6 is a diagram illustrating an example of the structure of the billing information item generation method according to Embodiment 1. The billing information item generation method 213 includes: a billing information item 600 for identifying the relevant item of the billing information; and a C-WRD-ID 601 and an E-WRD-ID 602 for identifying the relevant entry of the contract-related term data source 214 illustrated in FIG. 7. The C-WRD-ID 601 is an ID of a term whose type 700 of the contract term data source 214 (see FIG. 7) falls under “contract-related information.” The E-WRD-ID 602 is an ID of a term whose type 700 of the contract term data source 214 fall s under “environment-dependent information.”

FIG. 7 is a diagram illustrating an example of the structure of the contract-related term data source according to Embodiment 1. The contract-related term data source 214 includes: the type 700 for classifying terms; a WRD-ID 701 for identifying a term item in the same type 700; a term item 702 which is a name of the term item; an access path 703 for extracting a value regarding the term item 702 from the information acquired from the contract information 203 or the usage amount information 211; and a route item 704 which stores the WRD-ID of a term item serving as a route in the same type 700. The access path 703 varies depending on a data format of an extraction source; and, for example, when the data format of the extraction source is JSON, the access path is JSON Path; when the data format of the extraction source is a table, the access path is a table name+a column name; when the data format of the extraction source is XML, the access path is XML Path; and when the data format of the extraction source is a Key Value format, the access path is a Key name.

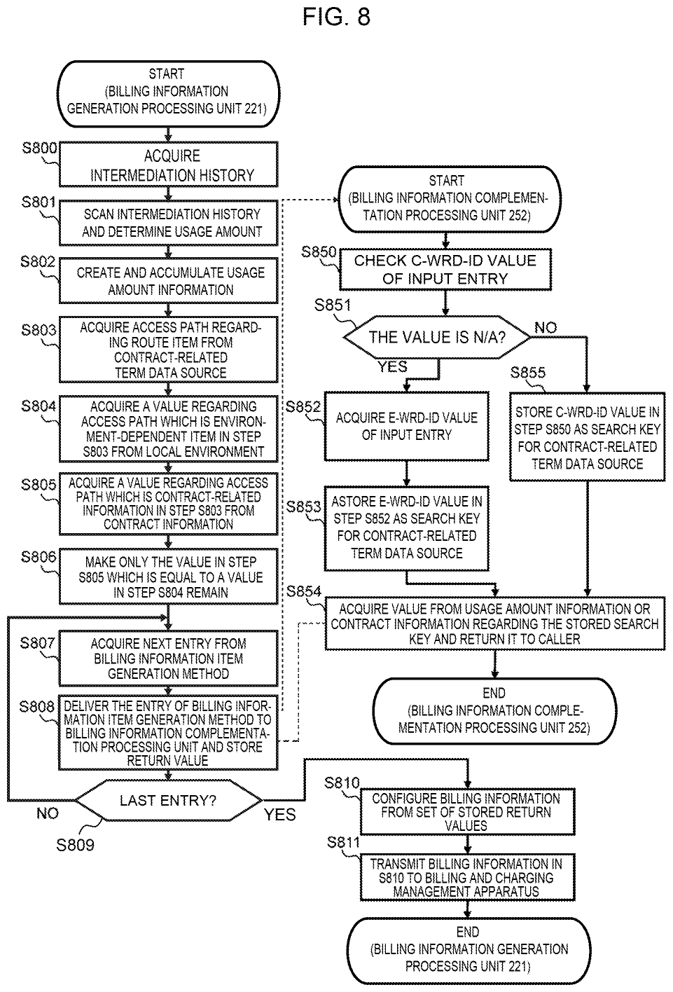

FIG. 8 is a diagram illustrating an example of a processing flowchart of the billing information generation processing unit and the billing information complementation processing unit according to Embodiment 1. The billing information generation processing unit 221 starts processing based on a specified execution trigger (such as a charging execution day, a specified interval, or an explicit start by a user or an external program).

The billing information generation processing unit 221 firstly evokes the intermediation history acquisition unit 202 and acquires the intermediation history 201 from the service intermediation apparatus 111 (step S800). The billing information generation processing unit 221 scans the acquired intermediation history 201 and determines the usage amount (step S801). Scanning is to, for example, count a specified keyword or acquire a metric value in the intermediation history 201.

Next, the billing information generation processing unit 221 accumulates the usage amount information 211 created from the usage amount which was determined in step S801 (step S802). Then, the billing information generation processing unit 221 acquires the access path 703 regarding the route item 704 from the contract-related term data source 214 (step S803). Subsequently, the billing information generation processing unit 221 acquires a value regarding the access path 703 whose type 700 is the environment-dependent information, from among the access paths 703 regarding the route item acquired in step S803, from its own local environment (step S804). The local environment indicates databases, files, API's and so on in an IT system in an on-premise or cloud environment of the intermediation service business operator and is the usage amount information 211 in this embodiment.

Next, the billing information generation processing unit 221 acquires a value regarding the access path 703 whose type 700 is the contract-related information, from among the access paths 703 regarding the route item acquired in step S803, from the contract information 203 (step S805). Then, the billing information generation processing unit 221 compares the values obtained in step S804 and step S805. If the value obtained in S805 is equal to the value obtained in S804, then only the value in S805 is kept (step S806).

Subsequently, the billing information generation processing unit 221 acquires the next entry (or the first entry upon the first execution) from the billing information item generation method 213 (step S807). The billing information generation processing unit 221 starts executing the processing of the billing information complementation processing unit 222 by using the entry acquired in step S807 as an argument and additionally stores its return value (step S808).

Next, the billing information generation processing unit 221 checks whether the current entry is the last entry of the billing information item generation method 213 or not; and in a case of YES, the processing proceeds to step S810; and in a case of NO, the processing proceeds to step S807 (step S809).

In step S810, the billing information generation processing unit 221 configures the billing information 212 from a set of return values stored through evoking the processing of the billing information complementation processing unit 222 in step S808 once or more times. Next, the billing information generation processing unit 221 transmits the billing information 212 configured in step S810 to the billing and charging management apparatus 112 (step S811).

On the other hand, the billing information complementation processing unit 222 checks a value of the C-WRD-ID 601 of the entry which has been input from the billing information generation processing unit 221 (step S850). If the billing information complementation processing unit 222 finds, as a result of the check, that the value is N/A (or another defined value such as NULL or −1 indicating that there is no value) (step S851: YES), the processing proceeds to step S852; and if the value is not N/A (step S851: NO), the processing proceeds to step S855.

In step S852, the billing information complementation processing unit 222 acquires a value of the E-WRD-ID 602 of the entry which has been input from the billing information generation processing unit 221. Next, the billing information complementation processing unit 222 stores the value of the E-WRD-ID 602, which was acquired in step S852, as a search key for the contract-related term data source 214 (step S853).

On the other hand, in step S855, the billing information complementation processing unit 222 stores the value of the C-WRD-ID 601, which was acquired in step S850, as a search key for the contract-related term data source 214. The billing information complementation processing unit 222 acquires an entry of the contract-related term data source 214 regarding the search key stored in step S853 or step S855, acquires a target value from the usage amount information 211 or the contract information 203 by using the access path 703, and returns it to a caller (the billing information generation processing unit 221 which executes step S808) (step S854).

According to this embodiment, it is possible to generate the target billing information 212 by complementing the values of the respective items which are required to generate the billing information 212, through substitution, conversion, and reference, from the usage amount information 211 or the contract information 203 and the contract relationship 135 can be made efficient by generating the billing information for the back-end service providing business operator 120 who is a direct client of the intermediation service business operator 110.

### Embodiment 2

Embodiment 2 describes a method for generating the billing information according to a billing model when the billing model of a product (that is, a usage amount to be presented as a billed amount) varies depending on a business operator who charges the relevant amount.

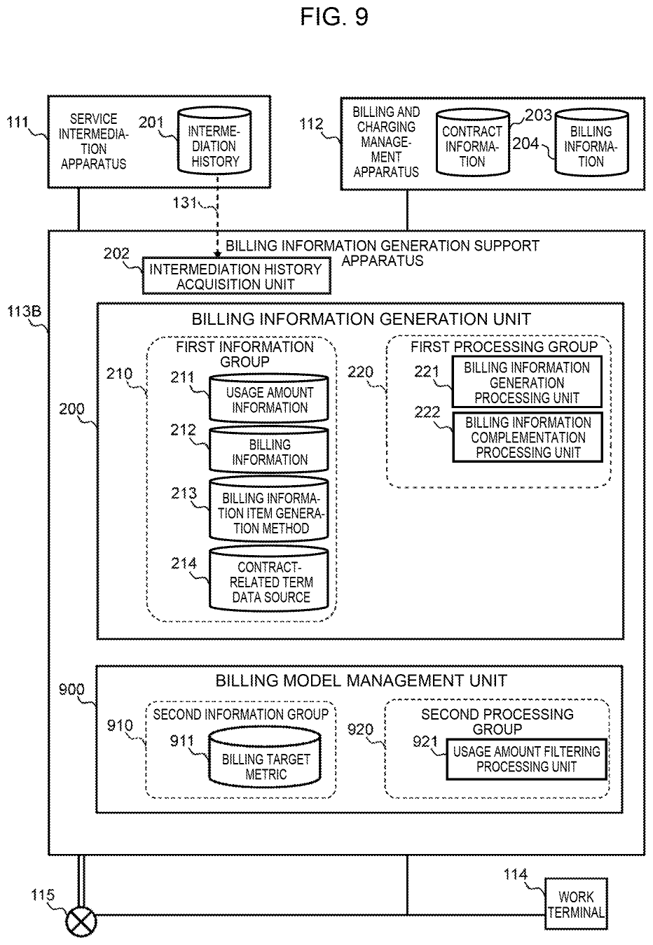

FIG. 9 is a diagram illustrating an example of the configuration of a billing information generation support apparatus according to Embodiment 2. A billing information generation support apparatus 113B according to Embodiment 2 further has a billing model management unit 900 as compared to the billing information generation support apparatus 113 according to Embodiment 1. The billing model management unit 900 according to this embodiment has a second information group 910 and a second processing group 920. The second information group 910 is, for example, information to be stored in the storage unit. The second processing group 920 is, for example, to be implemented by processing of each unit by execution of a program(s) by an arithmetic processing unit.

The second information group 910 has a billing target metric 911 which manages the metric based on which a billed amount should be presented. The second processing group 920 has a usage amount filtering processing unit 921 for executing filtering processing when generating the billing information 212 from the usage amount information 211 on the basis of the content of the billing target metric 911.

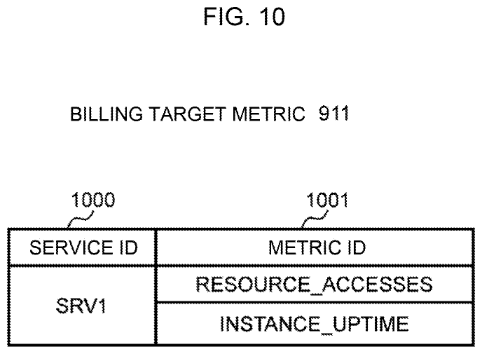

FIG. 10 is a diagram illustrating an example of the structure of the billing target metric according to Embodiment 2. The billing target metric 911 has: a service ID 1000 for identifying the back-end service provided by the business operator; and a metric ID 1001 for identifying the metric based on which the billed amount of the back-end service program 121 should be presented.

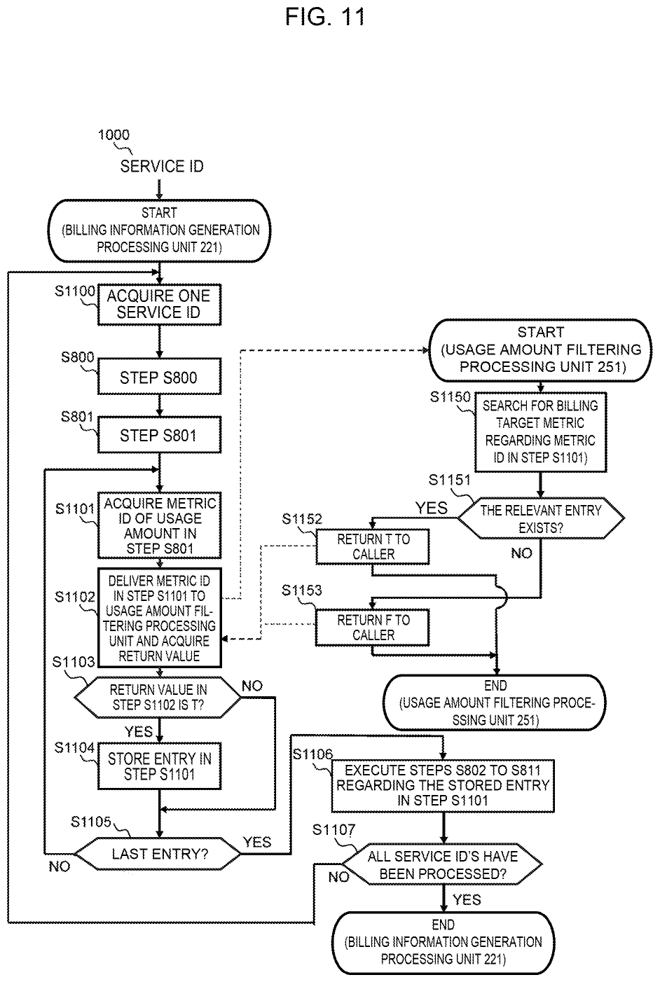

FIG. 11 is a diagram illustrating an example of a processing flowchart of the billing information generation processing unit and the usage amount filtering processing unit according to Embodiment 2. The billing information generation processing unit 221 operates by using one or more service ID's 1000 which were input in advance.

The billing information generation processing unit 221 firstly acquires one of the input service ID's 1000 and uses that service ID in subsequent steps (step S1100). Next, the billing information generation processing unit 221 executes step S800 and step S801 which are the same steps as those in FIG. 8. After step S801, the billing information generation processing unit 221 acquires the metric ID of the usage amount determined in step S801 (step S1101).

Next, the billing information generation processing unit 221 starts executing the usage amount filtering processing unit 921 by using the metric ID acquired in step 31101 and the service ID in step S1100 as arguments and acquires its return value (step S1102).

Next, the billing information generation processing unit 221 judges whether the return value received in step S1102 is True (T) or False (F); and in a case of True, the processing proceeds to step S1104; and in a case of False, the processing proceeds to step S1105 (step S1103).

In step S1104, the billing information generation processing unit 221 newly stores the entry of the usage amount in step S1101. The billing information generation processing unit 221 checks whether the entry of the usage amount for which the metric ID was acquired in step S1101 is the last entry or not; and if it is the last entry, the processing proceeds to step S1106; and if it is not the last entry, the processing proceeds to step S1101 (step S1105).

Next, the billing information generation processing unit 221 executes steps S802 to S811, which are the same steps as those in FIG. 8, with respect to a set of entries of the usage amount stored by executing step S1104 once or more times (step S1106).

In step S1107 after step S811, the billing information generation processing unit 221 checks whether the processing in steps S1100, S800, S801, and S1101 to S1106 has been executed or not, with respect to all the service ID's 1000 which were input in advance; and if the processing has been executed (step S1107: YES), the processing illustrated in FIG. 11 is terminated; and if the processing has not been executed (step S1107: NO), the processing proceeds to step S1100.

On the other hand, the usage amount filtering processing unit 921 searches the billing target metric 911 for the metric ID and the service ID which are input from the billing information generation processing unit 221 (step S1150). Subsequently, in step S1151, if the relevant entry exists in the metric ID and the service ID which were input in step S1150 (step S1151: YES), the usage amount filtering processing unit 921 proceeds to processing in step S1152; and if the relevant entry does not exist (step S1151: NO), the usage amount filtering processing unit 921 proceeds to processing in step S1153.

In step S1152, the usage amount filtering processing unit 921 returns True (T) as a Boolean value to the caller. On the other hand, in step S1153, the usage amount filtering processing unit 921 returns False (F) as the Boolean value to the caller.

In this embodiment, even when the billing model for the product (that is, the metric for the usage amount which should be presented as the billed amount) varies for each back-end service providing business operator 120 who is an entity to be charged, it is possible to generate the billing information 212 in accordance with the relevant billing model.

### Embodiment 3

Embodiment 3 describes a method for enhancing the efficiency of the contract relationship 134 between the back-end service utilization business operator 100 and the back-end service providing business operator 120 by generating the billing information in a state where the usage amount can be sorted for each back-end service utilization business operator 100 who is an indirect client.

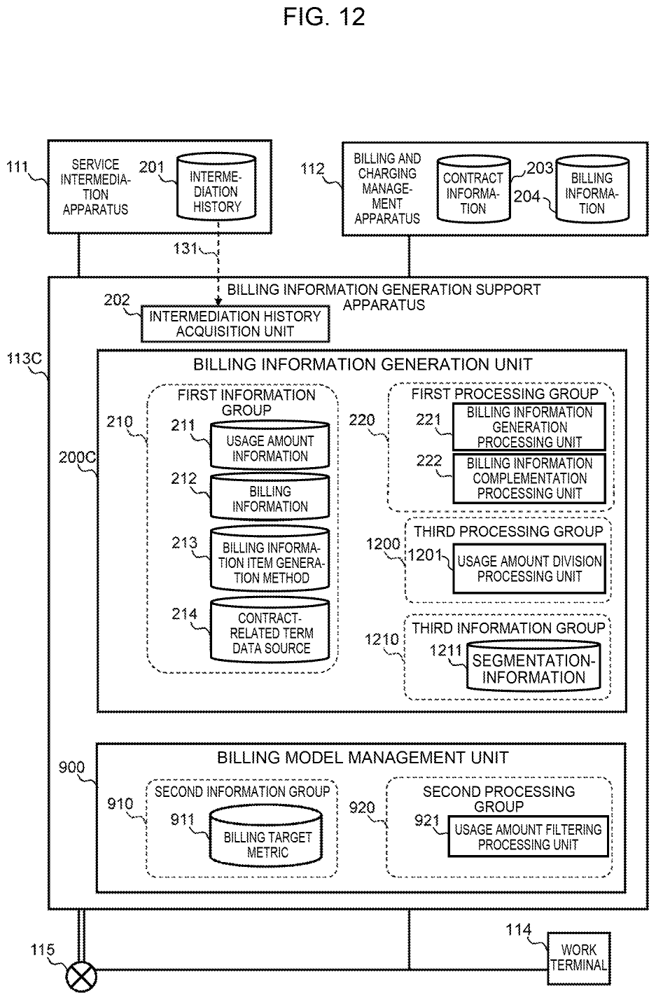

FIG. 12 is a diagram illustrating an example of the configuration of a billing information generation support apparatus according to Embodiment 3. Regarding a billing information generation support apparatus 113C according to Embodiment 3, a billing information generation unit 200C further has a third processing group 1200 and a third information group 1210 as compared to the billing information generation support apparatus 113B according to Embodiment 2. The third information group 1210 is, for example, information to be stored in the storage unit. The third processing group 1200 is, for example, to be implemented by processing of each unit by execution of a program(s) by an arithmetic processing unit.

Incidentally, the billing model management unit 900 can be omitted in the billing information generation unit 200C.

The third processing group 1200 has a usage amount division processing unit 1201 which divides (or segments) the usage amount information 211, for example, for each back-end service utilization business operator 100 who is an indirect client. The third information group 1210 has segmentation information 1211 for creating the details of the usage amount of the metric such as the back-end service utilization business operator 100, the back-end service utilization program 101, or its execution user.

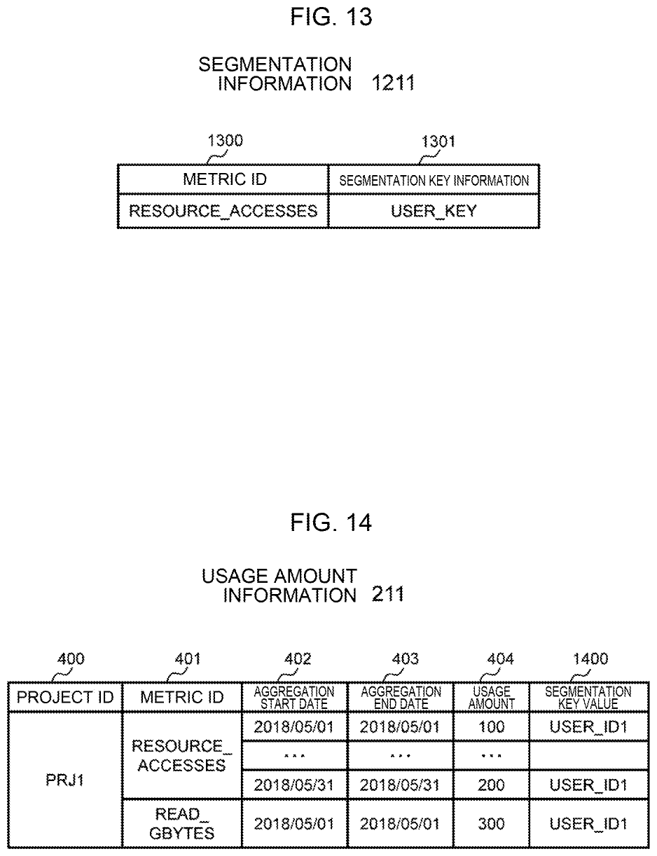

FIG. 13 is a diagram illustrating an example of the structure of the segmentation information according to Embodiment 3. The segmentation information 1211 includes: a metric ID 1300 associated with a metric ID 401 of the usage amount information 211 according to Embodiment 3 described later with reference to FIG. 14; and segmentation key information 1301 which is key information for segmentation of the usage amount. The segmentation key information 1301 is, for example, USER_KEY for segmenting the usage amount information 211 for each back-end service utilization business operator 100; however, any type of information may be used as long as the segmentation key information 1301 is a key for segmenting the usage amount for each metric.

FIG. 14 is a diagram illustrating an example of the structure of the usage amount according to Embodiment 3. The usage amount information 211 according to Embodiment 3 further has a segmentation key value 1400 as compared to the usage amount information 211 according to Embodiment 1 illustrated in FIG. 4.

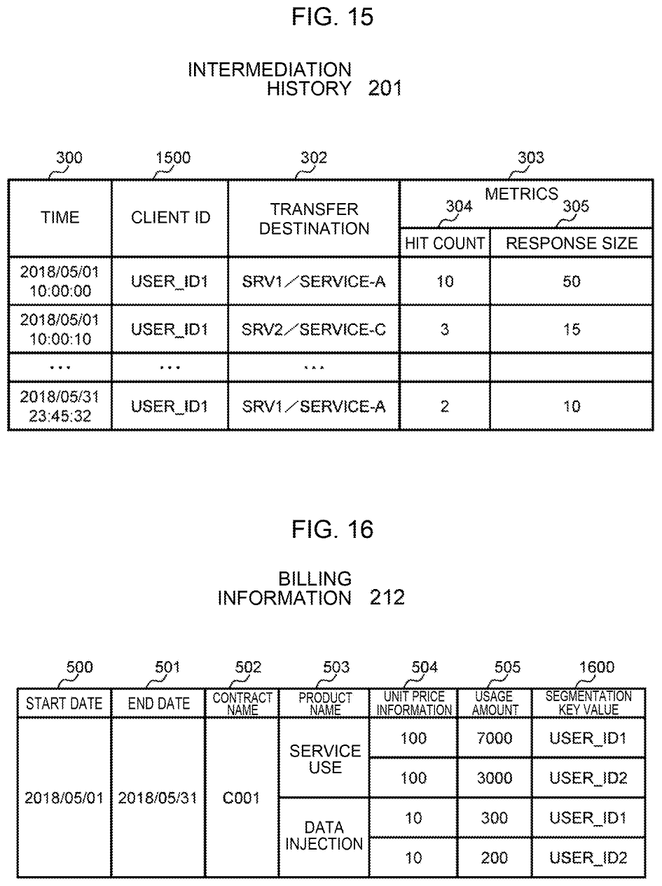

FIG. 15 is a diagram illustrating an example of the structure of the intermediation history according to Embodiment 3. The intermediation history 201 according to Embodiment 3 further includes a client ID 1500 for identifying the back-end service utilization program 101 as compared to the intermediation history 201 according to Embodiment 1 illustrated in FIG. 3. The client ID 1500 is, for example, an arbitrary character string (such as an application name or organization information) embedded in the back-end service utilization program, user information or a token for the back-end service, or an IP address.

FIG. 16 is a diagram illustrating an example of the structure of the billing information according to Embodiment 3. The billing information 212 according to Embodiment 3 further includes a segmentation key value 1600 as compared to the billing information 212 according to Embodiment 1 as illustrated in FIG. 5.

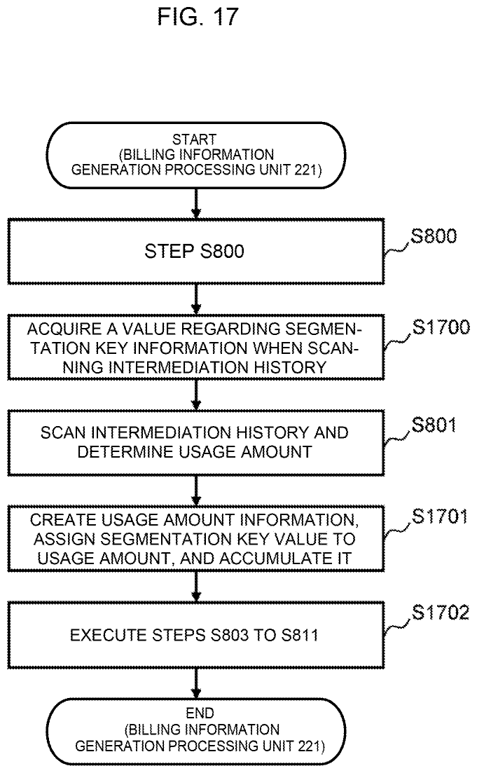

FIG. 17 is a diagram illustrating an example of a processing flowchart of the billing information generation processing unit according to Embodiment 3. The billing information generation processing unit 221 firstly executes step S800 which is the same step as that in FIG. 8. Next, the billing information generation processing unit 221 acquires a value of the segmentation key information 1301 (a segmentation key value), which is to be used when scanning the intermediation history 201 with respect to each metric ID 401, from the segmentation information 1211 (step S1700). Then, the billing information generation processing unit 221 scans the acquired intermediation history 201 and determines the usage amount (step S801). Next, the billing information generation processing unit 221 creates the usage amount information and assigns the value acquired in step S1700 to the usage amount as a segmentation key value 1400, and accumulates it (step S1701).

Then, the billing information generation processing unit 221 executes steps S802 to S811, which are the same steps as those in FIG. 8, with respect to a set of the accumulated entries of the usage amount information 211 (step S1106).

According to this embodiment, it is possible to generate the billing information in a state capable of further sorting the usage amount information 211 for each back-end service providing business operator 120, who is a direct client, into for each back-end service utilization business operator 100 who is an indirect client.

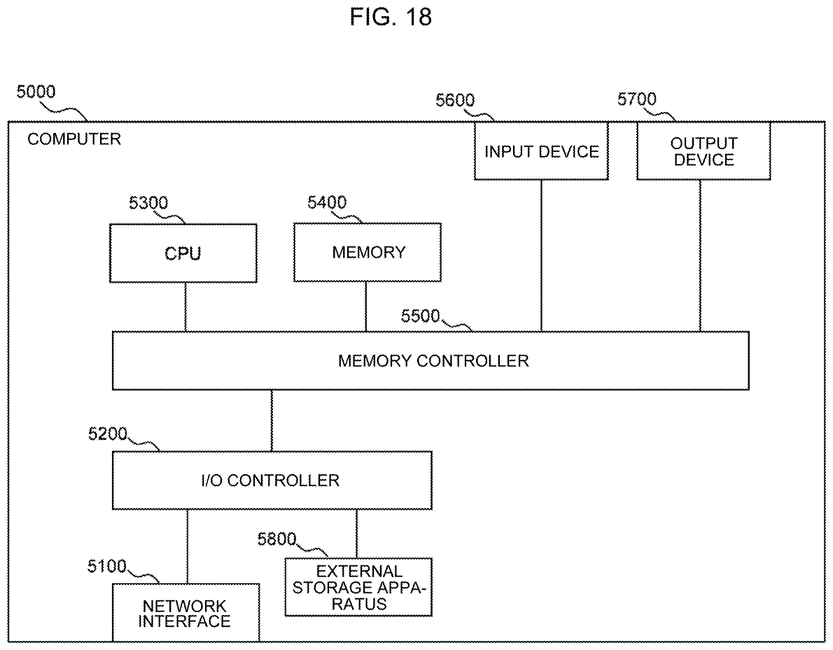

FIG. 18 is a diagram illustrating an example of the configuration of a computer that implements, for example, the billing information generation support apparatus. Regarding a computer 5000 which implements the billing information generation support apparatuses 113, 113B, 113C according to Embodiments 1 to 3, a CPU (Central Processing Unit) 5300, a memory 5400 such as a RAM (Random Access Memory), an input device 5600 (for example, a keyboard, a mouse, a touch panel, etc.), and an output device 5700 (for example, a video graphic card connected to an external display monitor) are mutually connected through a memory controller 5500. With the computer 5000, the billing information generation support apparatuses 113, 113B, 113C are implemented as a specified program is read from an external storage apparatus 5800 such as an SSD or an HDD via an I/O (Input/Output) controller 5200 and is executed by cooperation between the CPU 5300 and the memory 5400. Alternatively, the program for implementing the billing information generation support apparatuses 113, 113B, 113C may be acquired from an external computer through communication via a network interface 5100.

Incidentally, the program for implementing the billing information generation support apparatuses 113, 113B, 113C may be integrated with other programs for implementing the service intermediation apparatus 111, the billing and charging management apparatus 112, and so on.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Furthermore, to the extent of no inconsistency, part of the configuration of a certain embodiment can be replaced with the configuration of another embodiment and the configuration of another embodiment can be added to the configuration of a certain embodiment. Also, part of the configuration of each embodiment can be added, deleted, replaced, integrated, and divided. Furthermore, the respective apparatuses or the respective processing indicated in the embodiments may be distributed or integrated as appropriate. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### REFERENCE SIGNS LIST

100: back-end service utilization business operator
101: back-end service utilization program
110: intermediation service business operator
111: service intermediation apparatus
112: billing and charging management apparatus
113, 113B, 113C: billing information generation support apparatuses
114: work terminal
115: network
120: back-end service providing business operator
121: back-end service program
122: billing and charging management apparatus
131, 132, 133: communication relationships
134, 135: contract relationships
200, 200C: billing information generation units
201: intermediation history
202: intermediation history acquisition unit
203: contract information
204: billing information
210: first information group
211: usage amount
212: billing information
213: billing information item generation method
214: contract-related term data source
220: first processing group
221: billing information generation processing unit
222: billing information complementation processing unit
900: billing model management unit
910: second information group
911: billing target metric
920: second processing group
921: usage amount filtering processing unit
1200: third processing group
1201: usage amount division processing unit
1210: third information group
5000: computer
5300: CPU
5400: memory

1. A billing information generation support method for improving the generation of billing information, comprises a processor:
calculating usage amount information that retains a usage amount of a service program calculated from intermediation history and storing the usage amount information in a memory communicatively coupled to the processor;
calculating an information item which is required to generate billing information from at least one of the usage amount information and contract information;
extracting a contract-related term data source that retains a method for acquiring a value of the information item from at least one of the usage amount information and the contract information;
extracting a route item from the contract-related term data source
calculating an environment-dependent access path value from the extracted route item for environment-dependent information;
calculating a contract-related access path value from the extracted route item for contract-related information;
compares the environment-dependent access path value with the contract-related access path value, and when the environment-dependent access path value is equal to the contract-related access path value, both values are kept as return values;
calculating the billing information from the return values; and
sending, via an I/O interface, the billing information to a user.

2. The billing information generation support method according to claim 1,
wherein the memory retains billing target metric information that includes at least one index which is a target of filtering processing when the processor calculates the usage amount through scanning of the intermediation history with respect to the at least one index;
wherein the processor is further configured to execute the filtering processing on the at least one index when determining the usage amount on the basis of the billing target metric information; and
wherein the processor calculates the usage amount, by scanning the intermediation history with respect to the at least one index after executing the filtering processing, in the usage amount information.

3. The billing information generation support method according to claim 1,
wherein the memory retains segmentation information that includes the at least one index which are targets to be segmented by dividing the usage amount when the processor calculates the usage amount;
wherein the processor divides and segments the at least one index, which are used when determining the usage amount, on the basis of the segmentation information; and
wherein the processor calculates the usage amount, which is determined by scanning the intermediation history acquired with respect to the at least one index divided and segmented.

4. A non-transitory computer-readable medium, for improving the generation of billing information, including hardware design code stored thereon which when executed by a computer processor causes the system to perform a billing information generation support method, the method comprising:
calculating usage amount information that retains a usage amount of a service program calculated from intermediation history and storing the usage amount information in a memory communicatively coupled to the processor;
calculating an information item which is required to generate billing information from at least one of the usage amount information and contract information;
extracting a contract-related term data source that retains a method for acquiring a value of the information item from at least one of the usage amount information and the contract information;
extracting a route item from the contract-related term data source
calculating an environment-dependent access path value from the extracted route item for environment-dependent information;
calculating a contract-related access path value from the extracted route item for contract-related information;
compares the environment-dependent access path value with the contract-related access path value, and when the environment-dependent access path value is equal to the contract-related access path value, both values are kept as return values;
calculating the billing information from the return values; and
sending, via an I/O interface, the billing information to a user.

5. The computer-readable medium according to claim 4,
wherein the memory retains billing target metric information that includes at least one index which is a target of filtering processing when the processor calculates the usage amount through scanning of the intermediation history with respect to the at least one index;
wherein the processor is further configured to execute the filtering processing on the at least one index when determining the usage amount on the basis of the billing target metric information; and
wherein the processor calculates the usage amount, by scanning the intermediation history with respect to the at least one index after executing the filtering processing, in the usage amount information.

6. The computer-readable medium according to claim 4, wherein:
the memory retains segmentation information that includes the at least one index which are targets to be segmented by dividing the usage amount when the processor calculates the usage amount;
the processor divides and segments the at least one index, which are used when determining the usage amount, on the basis of the segmentation information; and
the processor calculates the usage amount, which is determined by scanning the intermediation history acquired with respect to the at least one index divided and segmented.

7. A billing information generation support apparatus for improving the generation of billing information, comprises:
a processor;
an I/O interface; and
a memory communicatively coupled to the processor and I/O interface, the processor configured to:
calculate usage amount information that retains a usage amount of a service program calculated from intermediation history and store the usage amount information in the memory;
calculate an information item which is required to generate billing information from at least one of the usage amount information and contract information;
extract a contract-related term data source that retains a method for acquiring a value of the information item from at least one of the usage amount information and the contract information;
extract a route item from the contract-related term data source
calculate an environment-dependent access path value from the extracted route item for environment-dependent information;
calculate a contract-related access path value from the extracted route item for contract-related information;
compares the environment-dependent access path value with the contract-related access path value, and when the environment-dependent access path value is equal to the contract-related access path value, both values are kept as return values;
calculate the billing information from the return values; and
send, via an I/O interface, the billing information to a user.
